(19) United States
(12) Patent Application Publication
(10) Pub. No.: US 2020/0087477 A1
(43) Pub. Date: Mar. 19, 2020

(54) Foamable High Density Polyethylene Compositions and Articles Made Therefrom

(71) Applicant: ExxonMobil Chemical Patents inc., Baytown, TX (US)

(72) Inventors: Antonios K. Doufas, Houston, TX (US); Liang Li, Shanghai (CN); James T. Luce, Houston, TX (US)

(21) Appl. No.: 16/495,078

(22) PCT Filed: Feb. 27, 2018
(86) PCT No.: PCT/US2018/019946

§ 371 Date: Sep. 17, 2019

Related U.S. Application Data
(60) Provisional application No. 62/478,126, filed on Mar. 29, 2017.

(51) Int. Cl. C08J 9/12; C08J 9/14

(52) U.S. Cl. CPC C08J 9/122; C08J 9/142; C08J 2201/03; C08J 2323/26; C08J 2205/052; C08J 2203/12; C08J 2323/06; C08J 2203/02

(57) ABSTRACT

The present invention relates to modified high density polyethylene, foamable compositions and foam or foamed articles made therefrom. The invention also relates to processes to make the same.

### CROSS REFERENCE TO RELATED APPLICATIONS

This application claims the benefit of Ser. No. 62/478,126, filed Mar. 29, 2017, the disclosure of which is hereby incorporated by reference in its entirety.

### FIELD OF THE INVENTION

The present invention relates to modified high density polyethylene, foamable compositions and foamed articles made therefrom.

### BACKGROUND OF THE INVENTION

Low density polyethylene (LDPE) resins are widely used in various foam applications such as cushion/protective packaging, construction, insulation, sporting goods, medical applications etc. LDPE resins can be fabricated into foams having a wide range of foam densities using several different processes due to their high levels of long chain branching (LCB) and desirable rheological characteristics (melt strength and strain hardening). The combination of rheological and crystallization characteristics of LDPE resins contribute to their excellent processability and relatively wide foaming window. However, the LDPE foam products tend to have low stiffness due to the relatively low stiffness of the starting material.

High density polyethylene (HDPE) resins offer the higher stiffness necessary for some foam applications. However, they are generally difficult to foam during extrusion due to their limited foamability often caused by their linear molecular chain structure (e.g. no strain hardening, not sufficient melt strength etc.). Poor melt strength of HDPE appears to be one factor which makes it difficult to produce foamed articles therefrom. The melt strength of HDPE can be increased by increasing the HDPE molecular weight; however, the increase in molecular weight is accompanied by an increase in melt viscosity which interferes with processability and foamability.

It is desirable to develop a modified high density polyethylene that is suitable for foam applications in terms of good processability and wide foam density range but with higher stiffness than that achieved with LDPE. Foam applications that would benefit from increased article stiffness include rigid packaging, recreational equipment, tubing, structural foam, electrical insulation, buoyancy aids, packaging, insulation, cushioning applications, toys, household articles etc.

### SUMMARY OF THE INVENTION

The present invention is directed to a process to produce a polyethylene foam or foamed article comprising several steps. First, provide a starting high density polyethylene having a density of at least 0.930 g/cm3 as determined by ASTM D 792. Second, treat the starting high density polyethylene with oxygen or peroxide to produce a modified high density polyethylene. The modified high density polyethylene has one or more of i) a density of at least 0.930 g/cm3, as determined by ASTM D 792; ii) a melt index I2 (190° C./2.16 kg) within a range of from 0.50 g/10 min to 4.0 g/10 min, as determined by ASTM 1238; iii) a melt index I21 (190° C./21.6 kg) within a range of from 50 g/10 min to 400 g/10 min, as determined by ASTM 1238; and iv) a melt flow ratio I21/I2 within a range of from 40 to 100, as determined by ASTM 1238. Third, admixing the modified high density polyethylene with a foaming agent to produce a foamable composition. Finally, foaming the foamable composition to form a polyethylene foam or foamed article, where the polyethylene foam or foamed article has a density reduction of at least 70% from the density of the modified high density polyethylene.

The invention is also related to a polyethylene foam or foamed article, a modified high density polyethylene, and foamable composition produced by the aforementioned process.

Aspects of the invention relate to a modified high density polyethylene having one or more of the following features: a) a density of at least 0.930 g/cm³; b) a melt index I₂ (190° C./2.16 kg) within a range of from 0.50 g/10 min to 4.0 g/10 min; c) a melt index I₂₁ (190° C./21.6 kg) within a range of from 50 g/10 min to 400 g/10 min; d) a melt flow ratio I₂₁/I₂ within a range of from 40 to 100; wherein the modified high density polyethylene is made from a starting high density polyethylene being treated with oxygen or peroxide.

The present invention further provides a formable high density polyethylene composition and a foamed article made from the modified high density polyethylene, and process making thereof.

The modified high density polyethylene in the invention has tailored processability and foaming characteristics, while retaining the physical properties (e.g., increased stiffness) of HDPE. The inventive foamable high density polyethylene compositions comprising the modified high density polyethylene surprisingly produce closed cell foams with a wide range of foam densities including similar or lower foam density than that achieved with LDPE. In addition, the inventive foamable high density polyethylene compositions show a relatively broad range of foaming temperature window.

### DETAILED DESCRIPTION

As used herein, an “olefin,” alternatively referred to as “alkene,” is a linear, branched, or cyclic compound of carbon and hydrogen having at least one double bond. For purposes of this specification and the claims appended thereto, when a polymer or copolymer is referred to as comprising an olefin, including, but not limited to ethylene, hexene, and diene, the olefin present in such polymer or copolymer is the polymerized form of the olefin. For example, when a copolymer is said to have an “ethylene” content of 35 wt. % to 55 wt. %, it is understood that the mer unit in the copolymer is derived from ethylene in the polymerization reaction and said derived units are present at 35 wt. % to 55 wt. %, based upon the weight of the copolymer.

A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other.

The present invention provides a modified high density polyethylene having one or more of the following features: a) a density of at least 0.930 g/cm³; b) a melt index I₂ (190° C./2.16 kg) within a range of from 0.50 g/10 min to 4.0 g/10 min; c) a melt index I₂₁ (190° C./21.6 kg) within a range of from 50 g/10 min to 400 g/10 min; d) a melt flow ratio I₂₁/I₂ within a range of from 40 to 100; wherein the modified high density polyethylene is made from a starting high density polyethylene being treated with oxygen or peroxide.

The present invention further provides a formable high density polyethylene composition and a foamed article made from the modified high density polyethylene, and process making thereof. The term “foamable” means the high density polyethylene compositions may further comprise one or more foaming agent. When acted upon (by, for example, heating) to activate the foaming agent, the term “foamed” is used in the context.

### Modified High Density Polyethylene

The modified high density polyethylene in the present invention has one or more of the features as follows:
a) a density of at least 0.930 g/cm³, for example, 0.930 to 0.970 g/cm³, preferably 0.940 g/cm³ to 0.970 g/cm³, more preferably 0.940 g/cm³ to 0.965 g/cm³;
b) a melt index I₂ (190° C./2.16 kg) within a range of from 0.50 g/10 min to 4.0 g/10 min, preferably 1.0 g/10 min to 3.5 g/10 min, more preferably 1.0 g/10 min to 3.0 g/10 min;
c) a melt index I₂₁ (190° C./21.6 kg) within a range of from 50 g/10 min to 400 g/10 min, preferably from 60 g/10 min to 350 g/10 min, more preferably from 100 g/10 min to 300 g/10 min; and
d) a melt flow ratio I₂₁/I₂ within a range of from 40 to 100, preferably from 45 to 90, more preferably from 50 to 80.

The modified high density polyethylene is originated from a starting HDPE. The starting HDPE has a density of at least 0.930 g/cm³, preferably about 0.930 g/cm³ to about 0.965 g/cm³, as measured by ASTM D-792. The starting HDPE may be the product of gas phase, slurry or solution polymerization. Polymerization can be conducted in the presence of metallocene, or metallocene based catalysts, as well as with chromium or Ziegler catalysts. The starting HDPE can be a homopolymer of ethylene or modified to contain small amounts of comonomer selected from an alpha olefin containing 3 to 10 carbon atoms, preferably 4 to 10 carbon atoms; in these instances the polymer will contain greater than 95% of its weight as ethylene units. Useful starting HDPE in this invention include those commercially available from ExxonMobil Chemical Company in Houston, Tex.

In a preferred embodiment, the starting HDPE is a blend of a first HDPE and a second HDPE, where the first HDPE having a melt index I₂ which is at least 10, preferably 100, more preferably 1000, times the melt index I₂ of the second HDPE. Both the first and the second HDPE have a density of at least 0.930 g/cm³, preferably about 0.940 g/cm³ to about 0.965 g/cm³, as measured by ASTM D-792, and the density of the second HDPE is at least 3%, 5%, 7%, 9%, 11% or more, lower than the density of the first HDPE. The first HDPE present in an amount within the range of from 1.0 wt. % to 99.0 wt. %, preferably from 10.0 wt. % to 90.0 wt. %, more preferably from 20.0 wt. % to 80.0 wt. %.

Rheological properties of the modified high density polyethylene can be characterized through Small Angle Oscillatory Shear (SAOS) Rheology Test, by its low shear viscosity (measured at 0.1 rad/sec) and high shear viscosity (measured at 100 rad/sec). In a preferred embodiment, the modified high density polyethylene has a low shear viscosity within the range of from 3000 to 20000 Pa·s, preferably from 4000 to 15000 Pa·s, more preferably from 5000 to 13000 Pa·s, measured at 0.1 rad/s; and a high shear viscosity within the range of from 100 to 1500 Pa·s, preferably from 400 to 1000 Pa·s, more preferably from 500 to 900 Pa·s, measured at 100 rad/s.

The modified high density polyethylene also exhibits an increase in elasticity. Increasing elasticity indicates increased melt strength. Elasticity parameter is defined as the ratio of G′ to G″, the elastic modulus to the storage modulus at an angular frequency of 0.1 rad/s at 190° C. In a preferred embodiment, the HDPE compositions have an elasticity parameter within the range of from 0.05 to 0.9, preferably from 0.1 to 0.8, more preferably from 0.1 to 0.6, measured at 0.1 rad/s at 190° C. through Small Angle Oscillatory Shear (SAOS) Rheology Test.

In a preferred embodiment, the modified high density polyethylene is a multimodal polymer with different components having different weight average molecular weights, preferably bimodal polymers, and has an Mw/Mn of more than 5.0, preferably more than 8.0, more preferably more than 10.0, as determined by GPC method.

The modified high density polyethylene can be made from a process comprising: a) providing the starting high density polyethylene; b) treating the starting high density polyethylene with oxygen or peroxide to produce the modified high density polyethylene.

### Oxygen Modified High Density Polyethylene

In some embodiments, the starting HDPE is oxygen modified at elevated temperatures to produce the modified high density polyethylene using any known method. The starting HDPE can be contacted with an oxygen-containing gas and optionally with at least one antioxidant. The oxygen-containing gas can be provided in as a continuous or intermittent flow. The oxygen-containing gas may be a mixture of gases, at least one of which is oxygen or it can consist essentially of oxygen. In one embodiment the oxygen-containing gas is air.

In some embodiments, the oxygen concentration is <450.0 ppm (wt) oxygen, or <350.0 ppm (wt) oxygen, or <300.0 ppm (wt) oxygen, or <250.0 ppm (wt) oxygen, or <200.0 ppm (wt) oxygen. In particular embodiments, the oxygen concentration is 80.0 to about 300.0 ppm (wt).

### Peroxide Modified High Density Polyethylene

In some embodiments, the starting HDPE may be subjected to peroxide modification at elevated temperatures, which are above ambient. The level of peroxide added to the starting HDPE is generally in the range of from about 50 to about 5000 ppm. The temperature of the peroxide treatment is generally in the range of from about 150° C. to about 260° C.

The peroxides used in the present invention are high temperature peroxides that may undergo almost complete decomposition at normal compounding temperatures (200° C. to 260° C.). The half-life temperature of the peroxides used in the present invention at 0.1 hours is greater than 130° C. Half-life temperature at a given time is the temperature at which one half of the peroxide has decomposed. Suitable peroxides include but are not limited to dicumyl peroxide, 2,5-dimethyl-2,5-di-(tert-butyl peroxy) hexane, tert-butyl cumyl peroxide, di-(2-tert-butylperoxyisopropyl) benzene, di-tert-butyl peroxide, 2,5-dimethyl-2,5-di-(tert-butylperoxy)hexyne-3, cumene hydroperoxide. The peroxide may be pre-blended with the starting HDPE or introduced separately as a liquid feed, such as in a mineral oil carrier and compounded using known compounding methods, for example, in a compounding extruder.

Treatment of the starting HDPE is preferably in a nitrogen atmosphere. Nitrogen may be introduced to the zone of HDPE treatment at the feed throat of the compounding extruder so as to minimize exposure to oxygen. Compounding under this condition significantly enhances the crosslinking efficiency of the peroxide. The resultant peroxide treated HDPE retains its thermoplastic properties.

The starting HDPE may also be compounded or admixed with at least one antioxidant. The role of antioxidant stabilizers is to protect the polymer from oxidative degradation after compounding or admixing and thus preserve its strength properties. The mechanism for degradation of HDPE via oxidation is an autocatalyzed, free radical chain process. During this process, hydroperoxides are formed which decompose into radicals and accelerate the degradation. Antioxidants prevent this degradation by (1) scavenging radicals to interrupt the oxidative chain reaction resulting from hydroperoxide decomposition and (2) consuming hydroperoxides.

The antioxidants contain one or more reactive hydrogen atoms which tie up free radicals, particularly peroxy radicals, forming a polymeric hydroperoxide group and relatively stable antioxidant species. The antioxidant in the HDPE is in the range of from about 300 to about 3000 ppm based on the desired level of oxidative stability desired in the final foamed product. The phenolic antioxidants are the largest selling antioxidant used in plastics today; they include simple phenols, bisphenols, thiobisphenols and polyphenols. Primary antioxidants include hindered phenols such as Ciba Geigy's Irganox 1076, 1010 and Ethyl 330.

### Foamable High Density Polyethylene (HDPE) Compositions

The foamable HDPE compositions comprising the modified high density polyethylene may further comprise one or more foaming agents. Suitable foaming agents include both physical foaming agents and chemical foaming agents. Chemical foaming agents include azodicarbonamide, azodiisobutyro-nitrile, benzenesulfonhydrazide, 4,4-oxybenzene sulfonylsemicarbazide, p-toluene sulfonyl semi-carbazide, barium azodicarboxylate, N,N′-dimethyl-N,N′-dinitrosoterephthalamide, and trihydrazino triazine. Some are known by their tradenames, such as Hydrocerol™ by Boehringer Ingelheim Chemical Inc., which is a sodium salt of polycarbonate acid and carbonate compounds in polyolefin matrix. As is known, this has a relatively low initiation temperature and the foaming agent can be selected to have a higher or lower initiation temperature as desired for a given application.

Foaming agents can be organic or inorganic agents. Suitable organic foaming agents include aliphatic hydrocarbons having 1-9 carbon atoms, halogenated aliphatic hydrocarbons, having 1-4 carbon atoms, and aliphatic alcohols having 1-3 carbon atoms. Aliphatic hydrocarbons include methane, ethane, propane, n-butane, isobutane, n-pentane, isopentane, neopentane, and the like. Examples of fluorinated hydrocarbon include methyl fluoride; perfluoromethane; ethyl fluoride; 1,1-difluoroethane (HFC-152a); 1,1,1-trifluoroethane (HFC-143a); 1,1,1,2-tetrafluoro-ethane (HFC-134a); pentafluoroethane; perfluoroethane; 2,2-difluoropropane; 1,1,1-trifluoropropane; perfluoropropane; perfluorobutane; and perfluorocyclobutane. Partially halogenated chlorocarbons and chlorofluorocarbons for use in this invention include methyl chloride; methylene chloride; ethyl chloride; 1,1,1-trichloroethane; 1,1-dichloro-1-fluoroethane (HCFC-141b); 1-chloro-1,1-difluoroethane (HCFC-142b); 1,1-dichloro-2,2,2-trifluoroethane (HCFC-123); and 1-chloro-1,2,2,2-tetrafluoroethane (HCFC-124). Fully halogenated chlorofluorocarbons include trichloromonofluoromethane (CFC-11); dichlorodifluoromethane (CFC-12); trichlorotrifluoroethane (CFC-113); dichlorotetrafluoroethane (CFC-114); chloroheptafluoropropane; and dichlorohexafluoropropane. Fully halogenated chlorofluorocarbons are not preferred. Aliphatic alcohols useful as foaming agents include methanol, ethanol, n-propanol, and isopropanol.

Suitable inorganic foaming agents include carbon dioxide, nitrogen, argon, water, air, nitrogen, and helium. Inorganic foaming agents also include:

sodium bicarbonate; sodium carbonate;
ammonium bicarbonate; ammonium carbonate; ammonium nitrite;
nitroso compounds, such as N,N′-dimethyl-N,N′-dinitrosoterephthalamide and N,N′-dinitrosopentamethylene tetramine;
azo compounds, such as azodicarbonamide, azobisisobutylonitrile, azocyclohexylnitrile, azodiaminobenzene, and bariumazodicarboxylate;
sulfonyl hydrazide compounds, such as benzene sulfonyl hydrazide, toluene sulfonyl hydrazide, p,p′-oxybis(benzene sulfonyl hydrazide), and diphenyl sulfone-3,3′-disulfonyl hydrazide; and
azide compounds, such as calcium azide, 4,4′-diphenyl disulfonyl azide, and p-toluene sulfonyl azide.

In a preferred embodiment, the foaming agent is selected from the group consisting of: butane, isobutene, carbon dioxide, pentane, hexane, heptane, benzene, toluene, methyl chloride, trichloroethylene, dichloroethane, trichlorofluoromethane,

The amount of foaming agent added into the modified high density polyethylene (typically the polymer melt) to make the foamable HDPE composition (typically a gel) is preferably from 0.01 to 10 wt. % and most preferably from 0.5 to 6.0 wt. %, based on the weight of the composition. The level of foaming agent is often altered to obtain a desired foam density.

A foaming assistant can be used with the foaming agent. The simultaneous use of the foaming agent with a foaming assistant contributes to lowering of the decomposition temperature of the foaming agent, acceleration of decomposition and homogenization of bubbles. Examples of the foaming assistant may include organic acids such as salicylic acid, phthalic acid, stearic acid and nitric acid, urea and derivatives thereof. The amount of foaming assistant incorporated into the HDPE composition (typically the polymer melt) is preferably from 0.01 to 10 wt. % and most preferably from 0.1 to 5 wt. %, preferably 0.5 to 3 wt. %, based on the weight of the composition.

The foamable high density polyethylene composition can be produced through the following process: a) providing the starting high density polyethylene; b) treating the starting high density polyethylene with oxygen or peroxide to produce the modified high density polyethylene; c) admixing the modified high density polyethylene with a foaming agent.

### Foam and Foamed Articles

The foam and foamed articles of this invention typically utilize a foaming agent to cause expansion of the foamable HDPE compositions by foaming. The process of foaming is well known in the art, and any suitable means is useful in the present invention.

The foamed articles have certain desirable features. In a preferred embodiment of the invention, foam density of the foamed article is within a range of from 0.05 g/cm³ to 0.70 g/cm³, preferably from 0.10 g/cm³ to 0.50 g/cm³, more preferably from 0.10 g/cm³ to 0.30 g/cm³; density reduction of the foamed article is at least 70%, preferably 80%, more preferably 90%. The foamed articles can have a closed cell structure.

A foaming process for making the foamed articles comprising: a) providing a starting high density polyethylene; b) treating the starting high density polyethylene with oxygen or peroxide to produce a modified high density polyethylene; c) admixing the modified high density polyethylene with a foaming agent to produce a foamable high density polyethylene composition; d) foaming the foamable high density polyethylene composition to form a foamed article.

### Applications

The foamable HDPE compositions may be used in any known application involving molding or extrusion, including consumer goods, industrial goods, construction materials, packaging materials, and automotive parts. For example, the foamed articles can be used in rigid packaging, recreational equipment, tubing, structural foam, electrical insulation, buoyancy aids, packaging, insulation, cushioning applications, toys, household articles etc.

### EXAMPLES

### Test Methods

Density is measured by density-gradient column, as described in ASTM D1505, on a compression-molded specimen that has been slowly cooled to room temperature (i.e., over a period of 10 minutes or more) and allowed to age for a sufficient time that the density is constant within +/−0.001 g/cm³. The units for density are g/cm³. Density Reduction is calculated in accordance with the equation as follows:

Density Reduction=(Resin Density−Foam Density)×100/Resin Density.

Melt Index (MI, also referred to as 12) is measured according to ASTM D-1238 at 190° C., under a load of 2.16 kg unless otherwise noted. The units for MI are g/10 min or dg/min High Load Melt Index (HLMI, also referred to as 121) is the melt flow rate measured according to ASTM D-1238 at 190° C., under a load of 21.6 kg. The units for HLMI are g/10 min or dg/min Melt Index Ratio (MIR) is the ratio of the high load melt index to the melt index, or I₂₁/I₂.

SAOS Rheology Test.

Dynamic shear melt rheological data was measured with an Advanced Rheometrics Expansion System (ARES) using parallel plates (diameter=25 mm) in a dynamic mode under nitrogen atmosphere. For all experiments, the rheometer was thermally stable at 190° C. for at least 30 minutes before inserting compression-molded sample of resin onto the parallel plates. To determine the samples viscoelastic behavior, frequency sweeps in the range from 0.01 to 385 rad/sec were carried out at a temperature of 190° C. under constant strain. Depending on the molecular weight and temperature, strains of 10% and 15% were used and linearity of the response (linear viscoelastic regime) was verified. A nitrogen stream was circulated through the sample oven to minimize chain extension or cross-linking during the experiments. All the samples were compression molded at 190° C. and no stabilizers were added. A sinusoidal shear strain is applied to the material if the strain amplitude is sufficiently small the material behaves linearly. It can be shown that the resulting steady-state stress will also oscillate sinusoidally at the same frequency but will be shifted by a phase angle δ with respect to the strain wave. The stress leads the strain by δ. For purely elastic materials δ=0° (stress is in phase with strain) and for purely viscous materials, δ=90° (stress leads the strain by 90° although the stress is in phase with the strain rate). For viscoelastic materials, 0<δ<90. The shear thinning slope (STS) was measured using plots of the logarithm (base ten) of the dynamic viscosity versus logarithm (base ten) of the frequency. The slope is the difference in the log(dynamic viscosity) at a frequency of 100 s⁻¹ and the log(dynamic viscosity) at a frequency of 0.01 s⁻¹ divided by 4. The low shear viscosity is measured at 0.1 rad/sec and the high shear viscosity is measured at 100 rad/sec.

Dynamic Viscosity is also referred to as complex viscosity or dynamic shear viscosity. The dynamic shear viscosity (η) versus frequency (ω) curves were fitted using the Cross model (see, for example, C. W. Macosco, RHEOLOGY: PRINCIPLES, MEASUREMENTS, AND APPLICATIONS, Wiley-VCH, 1994):

$${η}^{*} = \frac{{η}_{0}}{1 + {( λω )}^{1 - n}} .$$

The three parameters in this model are: η₀, the zero-shear viscosity; λ, the average relaxation time; and n, the power-law exponent. The zero-shear viscosity is the value at a plateau in the Newtonian region of the flow curve at a low frequency, where the dynamic viscosity is independent of frequency. The average relaxation time corresponds to the inverse of the frequency at which shear-thinning starts. The power-law exponent describes the extent of shear-thinning, in that the magnitude of the slope of the flow curve at high frequencies approaches 1-n on a log(η*)-log(ω) plot. For Newtonian fluids, n=1 and the dynamic complex viscosity is independent of frequency. For the polymers of interest here, n<1, so that enhanced shear-thinning behavior is indicated by a decrease in n (increase in 1-n).

Molecular Weight (weight-average molecular weight, Mw, number-average molecular weight, Mn, and Z-averaged molecular weight, Mz) and Molecular Weight Distribution (M_{w}/Mₙ) are determined using Size-Exclusion Chromatography, also called as Gel Permeation Chromatography (GPC). Equipment consists of a High Temperature Size Exclusion Chromatograph (either from Waters Corporation or Polymer Laboratories), with a differential refractive index detector (DRI), an online light scattering detector, and a viscometer. Three Polymer Laboratories PLgel 10 mm Mixed-B columns are used. The nominal flow rate is 0.5 cm³/min and the nominal injection volume is 300 μL. The various transfer lines, columns and differential refractometer (the DRI detector) are contained in an oven maintained at 135° C. Solvent for the SEC experiment is prepared by dissolving 6 grams of butylated hydroxy toluene as an antioxidant in 4 liters of reagent grade 1,2,4 trichlorobenzene (TCB). The TCB mixture is then filtered through a 0.7 μm glass pre-filter and subsequently through a 0.1 μm Teflon filter. The TCB is then degassed with an online degasser before entering the SEC.

Polymer solutions are prepared by placing dry polymer in a glass container, adding the desired amount of TCB, then heating the mixture at 160° C. with continuous agitation for about 2 hours. All quantities are measured gravimetrically. The TCB densities used to express the polymer concentration in mass/volume units are 1.463 g/ml at room temperature and 1.324 g/ml at 135° C. The injection concentration can range from 1.0 to 2.0 mg/ml, with lower concentrations being used for higher molecular weight samples.

Prior to running each sample the DRI detector and the injector are purged. Flow rate in the apparatus is then increased to 0.5 ml/minute, and the DRI allowed to stabilize for 8 to 9 hours before injecting the first sample. The LS laser is turned on 1 to 1.5 hours before running samples.

The concentration, c, at each point in the chromatogram is calculated from the DRI signal after subtracting the prevailing baseline, I_{DRI}, using the following equation:

c=K_{DRI}I_{DRI}/(dn/dc),

where K_{DRI} is a constant determined by calibrating the DRI using polystyrene as calibration standard, and (dn/dc) is the same as described below for the LS analysis. The processes of subtracting the prevailing baseline (i.e., background signal) and setting integration limits that define the starting and ending points of the chromatogram are well known to those familiar with SEC analysis. Units on parameters throughout this description of the SEC method are such that concentration is expressed in g/cm³, molecular weight is expressed in g/mole, and intrinsic viscosity is expressed in dL/g.

The light scattering detector is a Wyatt Technology High Temperature mini-DAWN. The polymer molecular weight, M, at each point in the chromatogram is determined by analyzing the LS output using the Zimm model for static light scattering (M. B. Huglin, LIGHT SCATTERING FROM POLYMER SOLUTIONS, Academic Press, 1971):

$$\frac{{K}_{o} c}{Δ R ( θ )} = \frac{1}{MP ( θ )} + 2 {A}_{2} c .$$

Here, ΔR(θ) is the measured excess Rayleigh scattering intensity at scattering angle θ, c is the polymer concentration determined from the DRI analysis, A₂ is the second virial coefficient, P(θ) is the form factor for a monodisperse random coil (described in the above reference), and Kₒ is the optical constant for the system:

$${K}_{o} = \frac{4 {π}^{2} {{n}^{2} ( dn / d c )}^{2}}{{λ}^{4} {N}_{A}} ,$$

in which N_{A} is Avogadro's number, and (dn/dc) is the refractive index increment for the system. The refractive index, n=1.500 for TCB at 135° C. and λ=690 nm. In addition, A₂=0.0015 and (dn/dc)=0.104 for polyethylene in TCB at 135° C.; both parameters may vary with average composition of an ethylene copolymer. Thus, the molecular weight determined by LS analysis is calculated by solving the above equations for each point in the chromatogram; together these allow for calculation of the average molecular weight and molecular weight distribution by LS analysis.

A high temperature Viscotek Corporation viscometer is used, which has four capillaries arranged in a Wheatstone bridge configuration with two pressure transducers. One transducer measures the total pressure drop across the detector, and the other, positioned between the two sides of the bridge, measures a differential pressure. The specific viscosity for the solution flowing through the viscometer at each point in the chromatogram, (ηₛ)ᵢ, is calculated from the ratio of their outputs. The intrinsic viscosity at each point in the chromatogram, [η]ᵢ, is calculated by solving the following equation (for the positive root) at each point i:

(ηₛ)ᵢ=cᵢ[η]ᵢ+0.3(cᵢ[η]ᵢ)^{2,}

where cᵢ is the concentration at point i as determined from the DRI analysis.

Assessment of Foam Cell Structure.

A colored alcohol dip test is used to determine the cell structure of foams is closed or open. First dipping a foamed rod sample into colored alcohol for 15 second, and cutting the sample to see whether the colored alcohol penetrated though (open) or not (closed) in the cell structure.

### Preparation of Modified High Density Polyethylene

Starting HDPE with different melt index, as shown in Table 1, is treated with peroxide to yield a peroxide modified high density polyethylene with improved foaming and processing characteristics (inventive HDPE). The starting HDPE in examples 2-1, 3-1, and a blend of starting HDPE in example 4-1 are respectively treated with 275 ppm of 2,5-dimethyl-2,5-di (tert-butylperoxy) hexane peroxide at 200° C. in a twin screw extruder to produce inventive HDPE of examples 2-2, 3-2 and 4-2. The peroxide is Triganox 101 E-10, manufactured by Akzo Inc.

TABLE 1
Properties of Polyethylene Products

| | | I₂ | I₂₁ | MIR | Density |
|---|---|---|---|---|---|
| No. | Description of Sample | (g/10 min) | (g/10 min) | I₂₁/I₂ | (g/cm³) |
| 1 | LDPE | 2.3 | 127.9 | 55.6 | 0.919 |
| 2-1 | Starting HDPE -1 | 7.3 | 152.4 | 20.9 | 0.948 |
| 2-2 | Inventive HDPE-1 | 2.3 | 90.6 | 39.4 | 0.947 |
| 3-1 | Starting HDPE-2 | 30.5 | | | 0.944 |
| 3-2 | Inventive HDPE-2 | 1.9 | 163.5 | 86.1 | 0.944 |
| 4-1 | HDPE component of | 100 | | | 0.968 |
| | a blend in a weight | 0.1 | 2.5 | 25 | 0.930 |
| | ratio 80/20 | | | | |
| 4-2 | Inventive HDPE blend | 3.7 | 332.3 | 89.8 | 0.958 |

As shown in Table 2, rheological characteristics of the resultant inventive HDPE are tested through SAOS and compared to a LDPE resin, which is commonly employed for producing low density (0.01-0.20 g/cm³) foam using extrusion technology and therefore used for comparative purposes.

The high shear viscosity (100 rad/sec) of the inventive example 4-2 is close to that of LDPE, which indicates easier relative processability of the inventive HDPE. The viscosity and elasticity at low shear of the inventive example 4-2 are higher than for LDPE, and the melt strength of the inventive example 4-2 is low, which is highly advantageous to be able to make stable closed cell foam with very high density reduction. The combination of similar high shear viscosity, higher low shear viscosity and elasticity indicates a balanced extrudability and foamability for the inventive HDPE.

TABLE 2
Rheological Characteristics of Inventive HDPE

| | No. | | | |
|---|---|---|---|---|
| | 1 | 2-2 | 3-2 | 4-2 |
| Samples | Control | Inventive | Inventive | Inventive |
| Complex viscosity@ | 8628.19 | 5117.26 | 8517.67 | 12375.10 |
| 0.1 rad/sec (Pa · s) | | | | |
| Complex viscosity@ | 445.9 | 840.9 | 599.3 | 558.7 |
| 100 rad/sec (Pa · s) | | | | |
| Elasticity Parameters | 0.354 | 0.180 | 0.351 | 0.526 |
| G′/G″ @ 0.1 rad/sec | | | | |
| First Crossover | 12.1 | 355.6 | 68.8 | 15.3 |
| Frequency (rad/sec) | | | | |
| First Crossover | 12098 | 119607 | 35269 | 16303 |
| Modulus (Pa) | | | | |

### Preparation of Foamed Articles

Foaming Process:

A tandem extrusion system, consisting of a 34 mm diameter co-rotating twin screw extruder feeding a 40 mm diameter single screw extruder, was used for the preparation of the foamed samples. Inventive HDPE resins were fed into the hopper of the twin-screw extruder through a solid metering feeder. Foaming agent was injected in the twin-screw extruder through a positive displacement pump at 20 L/D of the extruder, after a complete melting of the material was achieved. The barrel and the die temperatures of the single screw extruder were controlled using separate oil heaters to achieve proper cooling and temperature control. A rod die, consisting of two holes with 1.7 mm diameters, was used and attached at the end of the cooling extruder. The melt temperature was measured via a temperature probe in the melt behind the die. Typical process conditions are shown in Table 3 below.

TABLE 3
Typical Foaming Extrusion Conditions

| Extrusion Condition | Unit | Set Point |
|---|---|---|
| Zone #1 | ° C. | 177 |
| Zone #2 | ° C. | 193 |
| Zone #3 | ° C. | 207 |
| Zone #4 | ° C. | 424 |
| Adaptor #1 | ° C. | 218 |
| Adaptor #2 | ° C. | 221 |
| Die #2 | ° C. | 207 |
| Die #3 | ° C. | 207 |
| Die #4 | ° C. | 207 |
| Extruder Speed | rpm | 45 |
| Extruder AMP | % | 36-41 |
| Melt Temp at Extruder | ° C. | 199-210 |
| Melt Temp at Adaptor | ° C. | 210 |
| Extruder Pressure -End | PSI | 1600-2300 |

### Example 1

A LDPE resin as a control sample was foamed followed the above process. 3% isobutane, 0.5% talc (hydrated magnesium silicate, manufactured by Mistron Vapor R) and 1% Hydrocerol CF-40E (manufactured by Boehringer Ingelheim Chemical Inc.) were added in the sample.

### Example 2-2

An inventive HDPE with 2.3 of I₂ was foamed followed the foaming process. 3% isobutane, 0.5% talc (hydrated magnesium silicate, manufactured by Mistron Vapor R) and 1% Hydrocerol CF-40E (manufactured by Boehringer Ingelheim Chemical Inc.) were added in the sample.

### Example 3-2

An inventive HDPE with 1.9 of I₂ was foamed followed the above foaming process. 3% isobutane, 0.5% talc (hydrated magnesium silicate, manufactured by Mistron Vapor R) and 1% Hydrocerol CF-40E (manufactured by Boehringer Ingelheim Chemical Inc.) were added in the sample.

### Example 4-2

An inventive HDPE blend with 3.7 of I₂ (originated from a blend of a first HDPE with 100 of I₂ and a second HDPE with 0.1 of I₂ in a weight ratio of 80:20) was foamed followed the above foaming process. 3% isobutane, 0.5% talc (hydrated magnesium silicate, manufactured by Mistron Vapor R) and 1% Hydrocerol CF-40E (manufactured by Boehringer Ingelheim Chemical Inc.) were added in the sample.

Foam properties of the foamed articles were shown in Table 4. Inventive example 3-2 surprisingly produced low density foam (0.20-0.50 g/cm³) with relatively broad foaming temperature window (4.4° C.) when die pressure was less than 850 psi. Inventive example 4-2 unexpectedly produced lower density foam (as low as 0.10 g/cm³) than that of LDPE, which is commonly employed for producing low density foam.

TABLE 4
Foam Properties of the Foamed Articles

| No. | 1 | 2-2 | 3-2 | 4-2 |
|---|---|---|---|---|
| Foaming Temperature | 15 | 16 | 4.4 | 2.4 |
| window (° C.) | | | | |
| Foam Density (g/cm³) | 0.15-0.23 | 0.47-0.5 | 0.2-0.5 | 0.1-0.35 |
| Density Reduction (%) | 84 | 68 | 79 | 91 |
| Foam Cell Structure | Closed | Closed | Closed | Closed |

All documents described herein are incorporated by reference herein for purposes of all jurisdictions where such practice is allowed, including any priority documents, related applications, and/or testing procedures to the extent they are not inconsistent with this text, provided however that any priority document not named in the initially filed application or filing documents is not incorporated by reference herein. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including” for purposes of Australian law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

We claim:

1. A process to produce a polyethylene foam or foamed article comprising:
a) providing a starting high density polyethylene having a density of at least 0.930 g/cm³ as determined by ASTM D 792;
b) treating the starting high density polyethylene with oxygen or peroxide to produce a modified high density polyethylene having one or more of i) a density of at least 0.930 g/cm³, as determined by ASTM D 792, ii) a melt index I₂ (190° C./2.16 kg) within a range of from 0.50 g/10 min to 4.0 g/10 min, as determined by ASTM 1238, iii) a melt index I₂₁ (190° C./21.6 kg) within a range of from 50 g/10 min to 400 g/10 min, as determined by ASTM 1238, and iv) a melt flow ratio I₂₁/I₂ within a range of from 40 to 100, as determined by ASTM 1238;
c) admixing the modified high density polyethylene with a foaming agent to produce a foamable composition; and
d) foaming the foamable composition to form a polyethylene foam or foamed article, where the polyethylene foam or foamed article has a density reduction of at least 70% from the density of the modified high density polyethylene.

2. The process of claim 1, wherein the polyethylene foam or foamed article has a foam density within a range of from 0.10 g/cm³ to 0.50 g/cm³.

3. The process of claim 1 or claim 2, wherein the polyethylene foam or foamed article has a closed cell structure.

4. The process of any one of claims 1-3, wherein the peroxide has a half-life temperature of greater than 130° C., measured at 0.1 hours.

5. The process of any one of claims 1-4, wherein the peroxide comprises dicumyl peroxide, 2,5-dimethyl-2,5-di-(cert-butyl peroxy), tert-butyl cumyl peroxide, di-tert-butyl peroxide, or cumene hydroperoxide.

6. The process of any one of claims 1-5, wherein the foaming agent is within the range of from 0.5 wt. % to 6.0 wt. % based on the weight of the foamable composition.

7. The process of any one of claims 1-6, wherein the foaming agent is selected from the group consisting of: butane, isobutene, carbon dioxide, pentane, hexane, heptane, benzene, toluene, methyl chloride, trichloroethylene, dichloroethane, trichlorofluoromethane, dichlorodifluoromethane, trifluorochloromethane, 1,2,2-trichlorotrifluoroethane, and 1,2-dichlorotetrafluoroethane.

8. The process of any one of claims 1-7, wherein the modified high density polyethylene has a low shear viscosity within the range of from 5000 to 13000 Pa·s measured at 0.1 rad/s, and a high shear viscosity within the range of from 500 to 900 Pa·s measured at 100 rad/s, as determined in accordance with Small Angle Oscillatory Shear (SAOS) Rheology Test.

9. The process of any one of claims 1-8, wherein the modified high density polyethylene has an Mw/Mn of more than 5.0, as determined by GPC method.

10. The process of any one of claims 1-9, wherein the starting high density polyethylene comprises a first high density polyethylene and a second high density polyethylene, and the first high density polyethylene having a melt index I₂ which is at least 10 times the melt index I₂ of the second high density polyethylene.

11. The process of any one of claims 1-10, wherein the density of the second high density polyethylene is at least 3% lower than the density of the first high density polyethylene.

12. A polyethylene foam or foamed article produced by the process of any one of claims 1-11.

13. A modified high density polyethylene produced by the process of any one of claims 1-11.

14. A modified high density polyethylene having one or more of the following features:
i) a density of at least 0.930 g/cm³, as determined by ASTM D 792;
ii) a melt index I₂ (190° C./2.16 kg) within a range of from 0.50 g/10 min to 4.0 g/10 min, as determined by ASTM 1238;
iii) a melt index I₂₁ (190° C./21.6 kg) within a range of from 50 g/10 min to 400 g/10 min, as determined by ASTM 1238; and
iv) a melt flow ratio I₂₁/I₂ within a range of from 40 to 100, as determined by ASTM 1238;
wherein the modified high density polyethylene is made from a starting high density polyethylene being treated with oxygen or peroxide.

15. The modified high density polyethylene of claim 1, wherein the modified high density polyethylene has a low shear viscosity within the range of from 5000 to 13000 Pa·s measured at 0.1 rad/s, and a high shear viscosity within the range of from 500 to 900 Pa·s measured at 100 rad/s, as determined in accordance with Small Angle Oscillatory Shear (SAOS) Rheology Test.

16. The modified high density polyethylene of claim 1 or claim 2, wherein the modified high density polyethylene has an Mw/Mn of more than 5.0, as determined by GPC method.

17. The modified high density polyethylene of any one of claims 1-3, wherein the starting high density polyethylene comprises a first high density polyethylene and a second high density polyethylene, and the first high density polyethylene having a melt index I₂ which is at least 10 times the melt index 12 of the second high density polyethylene.

18. The modified high density polyethylene of claim 4, wherein the density of the second high density polyethylene is at least 3% lower than the density of the first high density polyethylene.

19. The modified high density polyethylene of claim 8, further comprising a foaming agent.

20. The modified high density polyethylene of claim 9, wherein the foaming agent is within the range of from 0.5 wt. % to 6.0 wt. %.

21. The modified high density polyethylene of any one of claims 9-10, wherein the foaming agent is selected from the group consisting of: butane, isobutene, carbon dioxide, pentane, hexane, heptane, benzene, toluene, methyl chloride, trichloroethylene, dichloroethane, trichlorofluoromethane, dichlorodifluoromethane, trifluorochloromethane, 1,2,2-trichlorotrifluoroethane, and 1,2-dichlorotetrafluoroethane.
